(19) United States
(12) Patent Application Publication
(10) Pub. No.: US 2022/0253878 A1
(43) Pub. Date: Aug. 11, 2022

(54) FINANCIAL INCENTIVES FOR STUDENT LOANS

(71) Applicant: Wells Fargo Bank, N.A., San Francisco, CA (US)

(72) Inventors: Abhijit Rao, Irvine, CA (US); Jasvir Kenneth Singh, Columbia Heights, MN (US)

(21) Appl. No.: 15/945,274

(22) Filed: Apr. 4, 2018

(51) Int. Cl. G06Q 30/02; G06Q 40/02

(52) U.S. Cl. CPC G06Q 30/0207; G06Q 40/025

(57) ABSTRACT

A method for determining a discount for an existing loan for a student includes comparing a score for each attribute of a plurality of attributes for the student with an average score for a corresponding attribute for a group of students. A weighting for one or more of the attributes is adjusted based on the comparing of each score for the one or more attributes for the student with the average score for the one or more attributes for the group of students. The adjusted weighting for the one or more attributes for the student is used to calculate a score that determines whether the student qualifies for the loan discount.

### BACKGROUND

College costs continue to rise, and college is becoming increasingly difficult to afford for many people. Many students are forced to take out large loans to attend college and are left with a high amount of debt to repay when they graduate. It can therefore be a hardship for students to repay their student loans, even in good economies in which well-paying jobs are available.

### SUMMARY

Embodiments of the disclosure are directed to a method implemented on an electronic computing device for determining a discount for an existing loan for a student, comprising: comparing a score for each attribute of a plurality of attributes for the student with an average score for a corresponding attribute for a group of students; adjusting a weighting for one or more of the attributes based on the comparing of each score for the one or more attributes for the student with the average score for the one or more attributes for the group of students; and using the adjusted weighting for the one or more attributes for the student to calculate a score that determines whether the student qualifies for the loan discount.

In another aspect, an electronic computing device comprises: a processing unit; and system memory, the system memory including instructions which, when executed by the processing unit, cause the electronic computing device to: identify a plurality of attributes that can be used to determine a discount for an existing loan for a student; determine a weighting for each of the plurality of attributes; obtain a numerical score for each of the plurality of attributes for the students; obtain a numerical score for each of the plurality of attributes for a group of students; for each of the plurality of attributes, calculate a variance between the numerical score for the attribute for the students and the numerical score for the attribute for the group of students; adjust the weighting for one or more of the plurality of attributes based on the variance for the corresponding attribute; obtain a numerical score for each attribute for one or more specific students; for each of the plurality of attributes, calculate a variance between the numerical score for the attribute for the student and the numerical score for the attribute for the one or more specific students; further adjust the weighting for the one or more of the plurality of attributes for the student based on the variance for the corresponding attribute between the numerical score for the attribute for the student and the numerical score for the attribute for the one or more specific students; and use the further adjusted weighting for the one or more of the plurality of attributes for the student, calculate a score that can determine whether the student can qualify for the loan discount.

In yet another aspect, an electronic computing device comprises: a processing unit; and system memory, the system memory including instructions which, when executed by the processing unit, cause the electronic computing device to: identify a plurality of attributes that can be used to determine a discount for an existing loan for a student; determine a weighting for each of the plurality of attributes; obtain a numerical score for each of the plurality of attributes for the students; obtain a numerical score for each of the plurality of attributes for a group of students; for each of the plurality of attributes, calculate a variance between the numerical score for the attribute for the students and the numerical score for the attribute for the group of students; adjust the weighting for one or more of the plurality of attributes based on the variance for the corresponding attribute; obtain a numerical score for each attribute for one or more specific students; for each of the plurality of attributes, calculate a variance between the numerical score for the attribute for the student and the numerical score for the attribute for the one or more specific students; further adjust the weighting for the one or more of the plurality of attributes for the student based on the variance for the corresponding attribute between the numerical score for the attribute for the student and the numerical score for the attribute for the one or more specific students; use the further adjusted weighting for the one or more attributes for the student, calculate a score that can determine whether the student can qualify for the loan discount; select a subset of the plurality of the one or more attributes; for each attribute in the subset of the plurality of attributes, obtain an attribute score by multiplying the further adjusted weighting for the attribute by a variance between the numerical score for the attribute for the student and an average numerical score for the attribute for the group of students; obtain an of average of each attribute score in the subset of plurality of attributes; normalize the average of the attribute scores to a scale between 1 percent and 100 percent; use a normalized average of the attribute scores to determine whether the student can qualify for the loan discount; obtain a maximum amount of the discount; and multiply the normalized average of the attribute scores by the maximum amount of the discount to determine a percentage of the discount.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports social and grade based interest rate incentives for student loans.

FIG. 2 shows example modules of the organization server computing device of FIG. 1.

FIG. 3 shows an example table of attributes, weightings and variances that can be used to calculate a reduction of interest for a student loan.

FIG. 4 shows an example method for determining an interest rate reduction for a student loan.

FIG. 5 shows another example operation of the method of FIG. 4.

FIG. 6 shows example physical components of the organization server computing device of the system of FIG. 1.

### DETAILED DESCRIPTION

The present disclosure is directed to systems and methods for providing financial incentives for students to obtain good grades and/or perform community service activities while attending college.

In some examples, the financial incentives can comprise receiving a reduced interest rate on current student loans based on a plurality of attributes which can include obtaining the good grades and performing the community service activities. The financial incentives can also be based on comparing student performance on the plurality of attributes with performance of one or more other students. For example, a group of students can be students compared nationally, within a region or state or within another grouping, such as students within the college. Further, a single other student (referred to as a “cohort”) can comprise an individual that has some similarity to the student, for example being in the same class as the student, coming from the same high school or having some other type of similarity.

A program for implementing a system for the reduced interest rates on the student loans can be implemented by an organization, such as a financial institution, that issued and/or manages the student loans. The organization can have several motivations for implementing such a program. Motivations can include creating a positive image of the organization, including positive media attention, providing good will for the student and for the community and encouraging the purchase of other organization products by the student and the student's family because of the good will created. In addition, by providing an added motivation for the student to achieve good grades and perform community service work, the chances are increased that the student will graduate college, obtain a good job and earn a high enough salary, making it more likely that the student will repay the student loans.

As discussed in more detail later herein, the plurality of attributes used to determine whether student can qualify for the reduced interest rate can include attributes other than good grades and community service work. Other attributes can include such items as standardized test scores, first in the family to graduate high school, first in the family to attend college, family history, including income and educational level of the student's parents, being a high school valedictorian, being on the dean's list in college, being a social activist, having an internship while in college and having earned any prestigious awards or scholarships, such as a Davidson Fellows scholarship. Other attributes are possible.

The systems and methods disclosed herein are directed to a computer technology that can compare student college academic and community service performance with other students and automatically determine, based on the performance and other factors, whether the student qualifies for an interest rate reduction for a current student college loan. An amount of the interest rate deduction can also be automatically determined. By automatically obtaining the performance and other information for the student and comparative group of students, computer efficiency is enhanced. The needed information can be automatically received, obviating the need for an organization server computing device to be manually updated with information that may reside at third party computing devices.

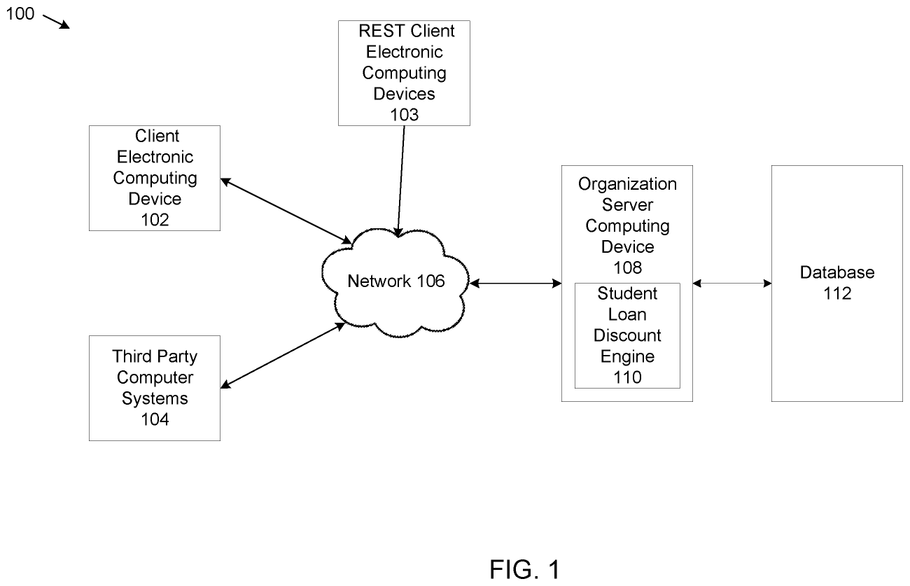

FIG. 1 shows an example system 100 that can support providing reduced rates for student loans based on school grades, community service and other attributes. System 100 includes a client electronic computing device 102, representational state transfer (REST) client electronic computing devices 103, third party computer systems 104, network 106, organization server computing device 108 and database 112. Organization server computing device 108 includes a student loan discount engine 110. More, fewer, or other components are possible.

The example client electronic computing device 102 is an electronic computing device that the student can use to provide information to organization server computing device 108. The information can include personal information regarding the student loan and information related to the plurality of attributes including verification information of high school performance, scholarships, internships and family history. Client electronic computing device 102 can comprise one or more of a desktop computer, laptop computer, tablet computer or a smartphone.

The example REST client electronic computing devices 103 are electronic computing devices that can have REST client software embedded in other systems, such as student loan management software, that may reside on the REST client electronic computing devices 103. The REST client software can make use of application program interface (API) commands to access information on organization server computing device 108 that can be exposed by an API on organization server computing device 108. The information can include data calculated on organization server computing device 108 and stored on database 112. Examples of this information can include data on student attributes, such as attribute scores, weightings and variances and loan discount percentages.

The example third party computer systems 104 can comprise electronic computing devices from third party organizations that can provide information regarding the plurality of attributes for the student and information regarding the plurality of attributes for the group of students and the cohort. Example third party organizations can include colleges, social services organizations, business organizations and government organizations. Other third party organizations are possible.

The example network 106 is a computer network and can be any type of wireless network, wired network and cellular network, including the Internet. Client electronic computing device 102 can communicate with organization server computing device 108 using network 106.

The example organization server computing device 108 is a server computing device of an organization, such as a financial institution, that provides college loans to students and that participates in a program to offer a discount on issued college loans based on the plurality of attributes. In some implementations, the financial institution can be a bank. In other implementations, the financial institution can be a government organization that issues loans. Organizational server computing device 108 can also provide support for the REST protocol and can provide an API that can permit REST clients to access information accessible from organizational server computing device 108 via the API.

The example student loan discount engine 110 processes the plurality of attributes to calculate a discount, comprising a reduced rate that can be provided to loans issued by the organization to the student. As discussed in more detail later herein, weightings can be assigned to each of the plurality of attributes being considered. The weightings can represent an importance of each attribute to the determination of the discount. The weightings for each attribute can be revised based on variances in a score for each attribute between the group of students and the cohort. Student loan discount engine 110 can then calculate a scalar score based on final revised weightings and performances for each attribute and then translate the scalar score into the discount that can be awarded to the student.

The example database 112 is a database associated with the organization of organization server computing device 108. Database 112 can store information regarding performance scores and weighting for each of the attributes for the student. Database 112 can also store variances in performance scores for each attributes between the group of students and the cohort. Database 112 can also store scalar scores and awarded student loan discount amounts for a plurality of students. Other information can also be stored.

Database 112 can be distributed over a plurality of databases. Organization server computing device 108 can be programmed to query (e.g. using Structured Query Language, SQL) database 112 to obtain the stored student loan information.

An example schema including, but not limited to, student loan information stored in database is shown below:
Student ID—a set or letters, numbers or other symbols that uniquely identifies a student;
Student Name—a name for the student associated with the student ID;
School ID—a set or letters, numbers or other symbols that uniquely identifies a college or university attended by the student;
School Name—a name of the college or university attended by the student;
Attribute pointer—a pointer to a storage area for attributes used for the student;
Initial weighting pointer—a pointer to a storage area for initial weightings for the attributes used for the student;
Group variance pointer—a pointer to a storage area for variances between the student and a group of students for the attributes used for the student;
Revised weighting per group variance pointer—a pointer to a storage area for revised weightings based on group variances for the attributes used for the student;
Cohort variance pointer—a pointer to a storage area for variances between the student and a cohort of the student;
Revised weighting per cohort pointer—a pointer to a storage area for revised weightings based on cohort variances for the attributes used for the student;
Scalar score for the student—a storage area for a scalar score for the student based on final attribute weightings for the student;
Normalized scalar score for the student—a storage area for a normalized scalar score the for student;
Discount percentage—a storage area for a percentage to which the student is eligible as a reduction in the student loan;

The above schema permits the database to be queried for data such data as attribute values and weightings and an amount of a loan discount, corresponding to an interest rate deduction for a current student loan.

As an example, the following messaging format can be used between the organization server computing device 108 and the database 112 to obtain loan discount information for the student.

| | |
|---|---|
| Student ID | Loan Discount |

As an example, the database 112 can use the following messaging format in responding to such a request.

| | |
|---|---|
| Student ID | Loan Discount Amount |

The response message can include the student ID and the loan discount amount. More, fewer, or different fields can be used. Other examples are possible.

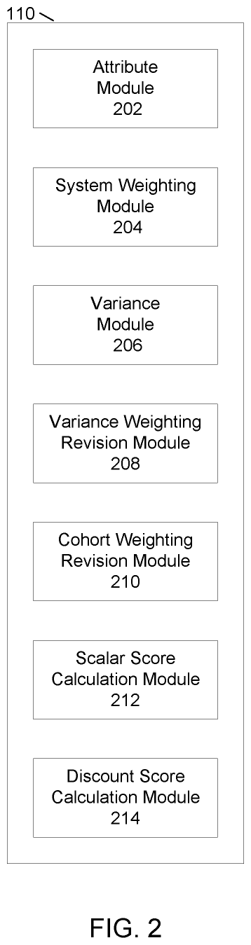

FIG. 2 shows example modules of organization server computing device 108. The example modules include an attribute module 202, a system weighting module 204, a variance module 206, a variance weighting revision module 208, a cohort weighting revision module 210, a scalar score calculation module 212 and a discount score calculation module 214. More, fewer or different modules are possible.

The example attribute module 202 identifies the plurality of attributes that are to be used to help determine whether the student can qualify for a discounted loan. In one example implementation, the organization can provide the student with a list of possible attributes and the student can select or prioritize the attributes that the student wants the organization to consider. The number of attributes that can be selected can be determined by the organization. In another implementation, the organization can select the attributes to be used. Example attributes can include attributes school grades, standardized test score, first in the family to graduate high school, first in the family to attend college, family history, including income and educational level of the student's parents, being a high school valedictorian, being on the dean's list in college, being a social activist, having an internship while in college and having earned any prestigious awards or scholarships.

The example system weighting module 204 determines initial weightings to be given to each attribute. Each initial weighting represents a level of importance of the attribute. In an example implementation, the initial weighting for each attribute is determined by the organization. In addition, for comparison purposes with the group of students and with the cohort, the same initial weightings can be used for each attribute for the group of students and for the cohort. A sum of the initial weightings for the attributes equals 100 percent.

The example variance module 206 determines a variance between each attribute for the student and each corresponding attribute for the group of students. The variance can comprise a number representing a deviation between a value of an attribute for the student compared with an average value of the attribute for the group of students. For example, for the attribute of student grades, if a grade point index (GPA) for the student is 3.8 and an average GPA for the group of students is 2.5, the variance can be a deviation between 3.8 and 2.5. In some implementations, the deviation can be represented by a subtraction, for example 1.3 (3.8-2.5). In other implementations, the deviation can be represented by a ratio, for example 1.52 (3.8/2.5). In still other implementations, the deviation can be obtained from a look-up table based on the subtraction or the ratio, for example 3, where a subtraction deviation of between 0 and 0.5 corresponds to a 1, a subtraction deviation of between 0.5 and 1 corresponds to a 2 and a subtraction deviation of between 1 and 1.5 corresponds to a 3. In this example, the deviation of 1.3 corresponds to a 3. Other implementations for calculating the variance are possible. Variance module 206 can also be used to determine attribute variances between a revised weighting based on the group of students and corresponding attribute values for a cohort.

The example variance weighting revision module 208 calculates a revision to the initial weighting based on the attribute variances between the student and the group of students. In some instances, variance weighting revision module 208 can consider a plurality of attributes when calculating the revision to the initial weighting for one or more attributes. For example, when calculating a revised weighting for student grades, the variance weighting revision module 208 can consider both a variance between the student and the group of students regarding student grades, but also a variance between the student and the group of students for an attribute such as community work. For example, when the variance for student grades is high but the variance between community work is low, indicating that the student had high grades but did not put in as many hours of community work as students in the group of students, the revised weighting for student grades can be lower than the initial weighting, reflecting that student grades for the group of students may have been negatively impacted by the additional hours of community work. Similarly, when the variance for student grades is high and the variance for community work is also high, the revised weighting can be higher than the initial weighting, reflecting that the student has higher grades than students in the group of students, in spite of putting in more hours for community work.

As another example, a revised weighting for standardized test scores may be increased over the initial weighting when a variance in family history has a negative deviation. The negative deviation in family history can indicate that the student came from a poor family and one where the student's parents did not attend college or may not have finished high school. This type of family may not have had the resources or the wherewithal to pay for test preparation for the student, putting the student at a disadvantage, but yet the student still had better standardized test scores than the large student group. Other such examples are possible.

The example cohort weighting revision module 210 revises the weightings from the variance weighting revision module 208 based upon attribute variances between the student and the cohort. As discussed earlier, herein, the cohort can comprise an individual that have some similarity to the student, for example being in the same class as the student, coming from the same high school or having some other type of similarity. When the student has a higher variance for an attribute than the cohort, the cohort weighting revision module 210 can increase the weighting of the attribute for the student. Similarly, when the student has a lower variance for an attribute that the cohort, cohort weighting revision module 210 can lower the weighting of the attribute for the student. As for the case with the variance weighting revision module 208, because the sum of all weightings add up to 100%, when a weighting for one attribute increases, the weightings for all other attributes can be decreased so that the weightings for the attributes still add up to 100%. Similarly, when a weighting for an attribute decreases, the weightings for all the other attributes can be increased so that the weightings for all the attributes still add up to 100%.

The example scalar score calculation module 212 calculates a scalar score, for example, a number between 1 and 100, that represents a degree to which the student is likely to receive a student loan discount from the organization. In an example implementation, the organization selects one or more of the attributes that it wishes to consider when calculating the scalar score. For example, the organization may decide to focus on only a small subset of the attributes used by attribute module 202. In an example implementation, only school grades, standardized test scores, community work and family history may be considered. In other implementations, other sets of attributes can be used.

For each selected attribute, scalar score calculation module 212 can calculate a final attribute result score. The final attribute result score can be calculated from the attribute weighting calculated by cohort weighting revision module 210 and the variance for the attribute between the student and the group of students. In one example implementation, the variance for the attribute can be multiplied by the attribute weighting. Other implementations are possible. For example, in another example implementation the final attribute score can be calculated from the attribute weighting calculated from variance revision module 208 and the variance for the attribute between the student and the group of students. For this example implementation, the cohort weightings are not used to calculate the final attribute score.

In addition, the final attribute result score can be adjusted due to one more external factors. An example external factor can be a personal family issue such as death or loss of employment or an unexpected disaster such as personal property damage from a fire, flood, hurricane or tornado. Depending on an extent of the external factor, the final attribute result score can be increased or decreased by a specific amount. As an example, the final attribute result score for school grades can be increased by 10 percent as a result of a death of a parent, the idea being that the student's grades were negatively affected by the death of the parent.

In some implementations, the final attribute score can be normalized using a lookup table. For example, to normalize the final attribute score to the range between 1 and 100, a multiplying factor can be applied to a pre-normalized final attribute score. For example if a determination is made that a highest pre-normalized final attribute score for an attribute is 50, the pre-normalized final attribute score can be multiplied by 2 to obtain the normalized final attribute score.

After final attribute result scores are calculated for each attribute, the final attribute result scores are processed further to calculate the scalar score. In an example implementation, the normalized final attribute scores are averaged to obtain the scalar score. Averaging comprises obtaining a sum of the normalized final attribute result scores and dividing the number of attributes. Other processing methods are possible.

The example discount score calculation module 214 calculates a discount percentage for the student loan from the scalar score. In an example implementation, a lookup table can be used to translate the scalar score into the discount percentage. A range of scalar scores can be correlated to a specific discount percentage. For example, if a maximum discount percentage being offered by the financial institution is two percent, a scalar score less than 50 can result in no change to the existing loan rate, a scalar score of between 71 and 75 can result in a reduction of one percent of the existing loan rate and a scalar score of between 76 and 100 can result in the maximum discount of a reduction of two percent of the existing loan rate. Other ways to translate the scalar score into a discount percentage are possible.

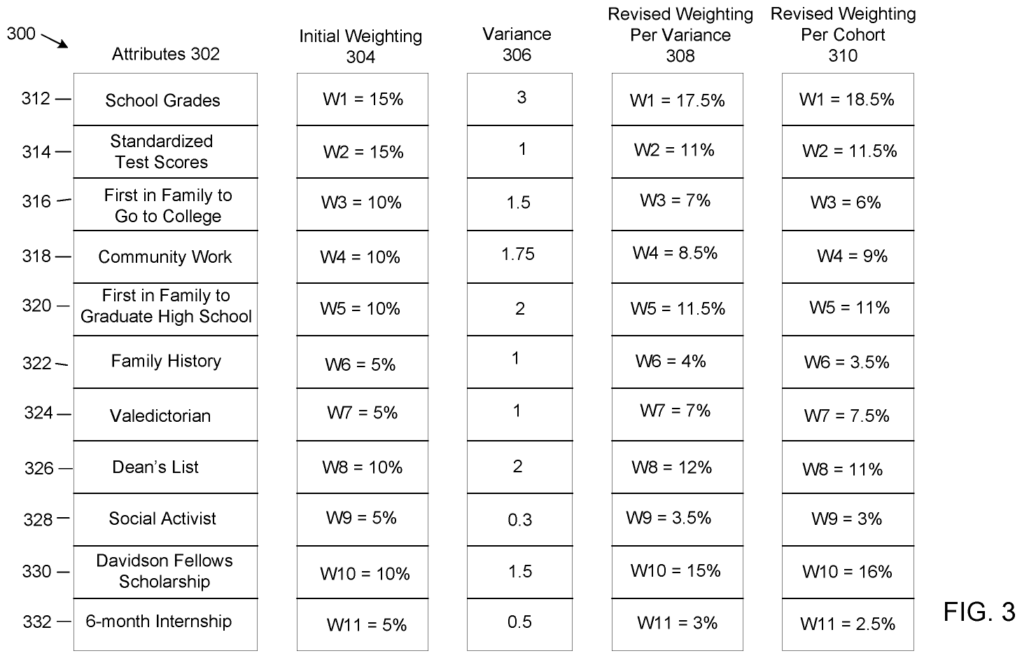

FIG. 3 shows an example table 300 showing attribute, weighting and variance values for a plurality of example attributes. The table 300 include columns for attributes 302, initial weighting 304, variance 306, revised weighting per variance 308 and revised weighting per cohort 310.

The example attributes 302 column lists example attributes that can be used to determine whether a student can qualify for an interest rate reduction in an existing student loan. The example attributes 302 include school grades 312, standardized test scores 314, first in family to go to college 316, community work 318, first in family to graduate high school, 320, family history 322, valedictorian 324, dean's list 326, social activist 328, Davidson Fellows scholarship 330 and 6-month internship 332. More, fewer, or different attributes are possible.

The example initial weighting column 304 lists initial weightings for each of the attributes in attributes 302 column. Each initial weighting is a percentage representing a relative importance of the associated attribute in the determination of the interest rate reduction. A sum of all the initial weightings is 100 percent. In an example implementation, the initial weightings are set by the organization that implements the interest rate reduction problem. In another example implementation, the student can provide suggestions for the initial weightings that are subject to approval by the organization.

For the example shown in FIG. 3, the initial weighting W1 for school grades 312 is 15%, the initial weighting W2 for standardized test scores 314 is 15%, the initial weighting W3 for first in family to go to college 316 is 10%, the initial weighting W3 for community work 318 is 10%, the initial weighting W5 for first family to graduate high school 320 is 10%, the initial weighting W6 for family history 322 is 5%, the initial weighting W7 for valedictorian 324 is 5%, the initial weighting W8 for dean's list is 10%, the initial weighting W9 for social activist 328 is 5%, the initial weighting W10 for Davidson Fellows scholarship is 10% and the initial weighting W11 for 6-month internship is 5%. Different initial weightings for these attributes are possible.

The example variance 306 column lists variances of performance of the same attributes by a group of students. The group of students can be students compared nationally, within a region or state or within another grouping, such as students within the college. As discussed earlier herein, the variance can comprise a number representing a deviation between a value of an attribute for the student compared with an average value of the attribute for the group of students. The deviation can also be represented by a ratio and the deviation can be obtained from a look-up table. Other implementations for the variance 306 are possible.

For the example shown in FIG. 3, the example variance for school grades 312 is 2, indicating that the school grades for the student is a factor of 2 greater than the average school grades of students in the group of students. As another example, the variance for standardized test scores 314 is 1, indicating that the standardized test scores for the student is about the same as the standardized test scores of students in the group of students. As a further example, the deviation for community work is 1.75, indicating that the student performed more community work by a factor of 1.75 than the average student in the group of students.

The example revised weighting per variance 308 column shows revised weightings for each attribute based on the variances in variance 306 column. As discussed earlier herein, the revised weighting for a particular attribute can consider both the variance between the student and the group for the attribute and for other related attributes. For example, as discussed, when the variance for student grades is high but the variance between community work is low, indicating that the student had high grades but did not put in as many hours of community work as students in the group of students, the revised weighting for student grades can be lower than the initial weighting, reflecting that student grades for the group of students may have been negatively impacted by the additional hours of community work.

As shown in FIG. 3, the example revised weighting W1 for school grades 312 increases to 17.5% from 15%. This reflects both the high variance of 2 for school grades 312 and the relatively high variance of 1.75 for community work 318, indicating that not only did the student achieve better grades than other students in the group, but did so in spite of putting in longer hours of community work than other students in the group.

Also, as discussed earlier herein, when a weighting for one attribute increases, the weighting for one or more other attributes needs to decrease so that the sum of the weighting percentages remains 100 percent. In some implementations, the weightings of one or more other attributes can decrease. In other implementations, the weightings of all the attributes can decrease by an equal percentage. Other implementations are possible. Similarly, when the weighting for one attribute decreases, the weightings of one or more of the other attributes need to decrease to maintain the sum of the weighting percentages at 100 percent.

The example revised weighting per cohort 310 column shows revised weightings of the revised weighting per variance 308 column based on performance variances between the student and the cohort. As examples, the revised weighting per cohort 310 for the school grades 312 attribute increases to 18.5% from 17.5%, reflecting that the student had better grades than the cohort. Similarly, the revised weighting per cohort 310 for community work 318 increases to 9% from 8.5%, reflecting that the student did more community work than the cohort. Also, as shown in FIG. 3, other weightings in the revised weighting per cohort 310 column are reduced so that the sum of all weighting percentages in the revised weighting per cohort 310 column remains at 100 percent. For example, the weighting for family history 322 decreases to 3.5% from 4% and the weighting for first in family to go to college 316 decreases to 6% from 7%.

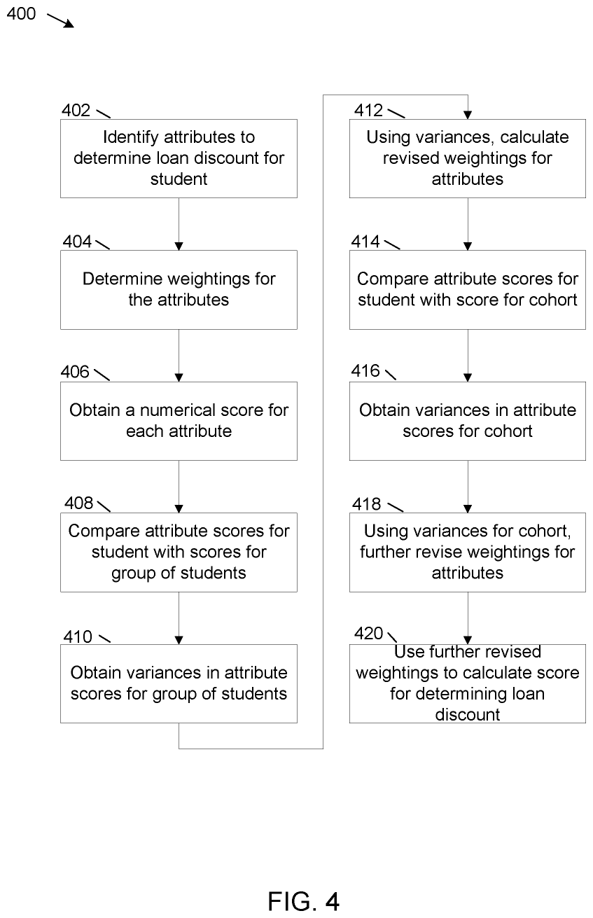

FIG. 4 shows a flowchart for an example method 400 for calculating a score for determining an interest rate reduction for a student loan. Method 400 assumes that the student has already obtained the student loan. The interest rate reduction amount is calculated based on student performance, community service work, and other factors to be considered after the student loan has been issued.

At operation 402, attributes that can be used to determine a loan discount for the student are identified. In an example implementation, the attributes are identified by an organization that issues the loan to the student, for example a bank or a financial institution specializing in student loans. By having the organization select the attributes, the same group of attributes can be used for all students and compared.

At operation 404, weightings are determined for each of the identified attributes. The weightings comprise a percentage weight to which the attributes contribute to the determination of the loan discount. A sum of the percentage weights for the attributes equals 100 percent.

At operation 406, a non-weighted numerical score is obtained for each identified attribute. The numerical scores correspond to a category for the attribute. For example, a numerical score for school grades can vary between 1.0 and 4.0 and a numerical score for standardized test scores can vary between 15 and 36. For attributes that are true or false, for example whether the student is the first in their family to go to college or whether the student has made the dean's list, the numerical score can be either 1 for true or 0 for false.

At operation 408, the numerical scores for each identified attribute for the student are compared with numerical scores for the same identified attributes for a group of students. The group of students can be students at selected colleges and universities in a state, region or the United States. The group of students can have at least one similarity with the student, for example the group of students can all be in the same academic year as the student.

At operation 410, variances are obtained between the numerical attribute scores for the student and the numerical attribute scores for the group of students. In an example implementation, a variance for an attribute can be obtained by dividing a student score for the attribute by a group score for the attribute. For example, for the school grade attribute where the numerical score for the student is 3.6 and the numerical score for the group is 3.0, the variance can be equal to 1.2 (3.6/3.0). Other calculation examples are possible.

At operation 412, the attribute variances can be used to calculate revised weightings for the attributes. When calculating the revised weightings for a particular attribute, variances for other attributes can be taken into consideration. For example, more weight can be given to a variance in student grades if the student performed more community work than the group average but still had a positive variance in school grades. In addition, when calculating the revised weightings for a particular attribute, the weightings of other attributes typically need to be adjusted. This is because the total percentage of all weightings needs to add up to 100 percent, so if a weighting for one attribute increases, weightings for one or more other attributes needs to decrease. In an example implementation, when a weighting for one attribute, for example school grades increases, weightings for all other attributes are decreased by equal amounts so that the total percentage for all attributes remains at 100 percent.

At operation 414, numerical attribute scores for the student are compared with numerical attributes scores for the cohort.

At operation 416, variances are obtained between the numerical attribute scores for the student and the numerical attribute scores for the cohort. For example, for each attribute, the numerical attribute score for the student can be divided by the numerical attribute score for the cohort.

At operation 418, the attribute variances between the student and the cohort are used to further revise the attribute weightings for the student. As with the revised weightings at operation 412, variances for other attributes can be taken into consideration and a sum of the percentages for all attributes equals 100 percent.

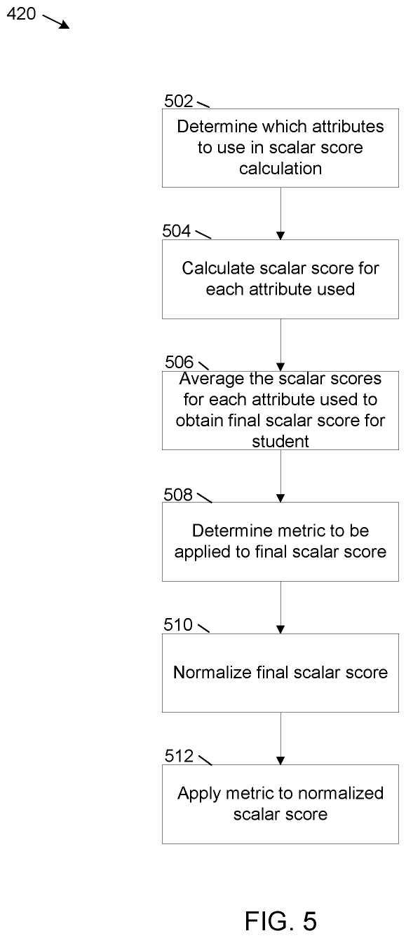

At operation 420, the revised weightings at operation 420 are used to calculate a scalar score for determining a possible loan discount for the student. Operation 420 is described in more detail with respect to FIG. 5.

FIG. 5 shows a flowchart for the example operation 420 of FIG. 4 for calculating the scalar score for determining the possible loan discount for the student.

At operation 502, a determination is made as to which attributes to use when calculating the scalar score. The organization that evaluates the attributes can decide whether to use all the attributes or a subset of the attributes. For example, the organization may focus on student grades, community work and 6-month internship and not consider standardized test scores or the personal background of the student. Other organizations can consider a different group of attributes, based on what the other organizations consider to be important.

At operation 504, a scalar score is obtained for each attribute used. In the implementation of method 400, the scalar score is obtained by multiplying the further revised weighting of operation 418 of an attribute by the group variance for the attribute of operation 410. The scalar score can be the result of the multiplication adjusted by one or more factors. The factors can include external events such as a death in the family, loss of employment of a family member and personal property damage from a fire, flood, hurricane or tornado. These factors can increase the scalar score when a determination is made that the student may have been negatively affected by the external event. In other implementations, other methods of calculating the scalar score can be used.

At operation 506, for method 400 the scalar scores for each attribute are averaged to obtain a final scalar score for the student. In other implementations, the final attribute scores can be combined in different ways. For example, the final attribute scores can be added together or they can be weighted according to a weighting priority determined by the organization. Other implementations are possible.

At operation 508, a determination is made as to a metric to be applied to the final scalar score. For method 400, the metric is loan discount points. In other implementations, other metrics such as money or loan terms can be used.

At operation 510, the final scalar score is normalized to obtain a normalized scalar score. For example, the final scalar score can be normalized to a scale between 1% and 100%.

At operation 512, the metric is applied to the normalized scalar score. For example, if the metric is loan discount points and the organization has allocated a maximum two percent loan discount, the normalized scalar score can determine what percentage of the maximum loan discount can be applied to the student. For example, if the normalized scalar score for the student is 50%, the student would be eligible for a 1 percent discount of the student's loan (0.5*2).

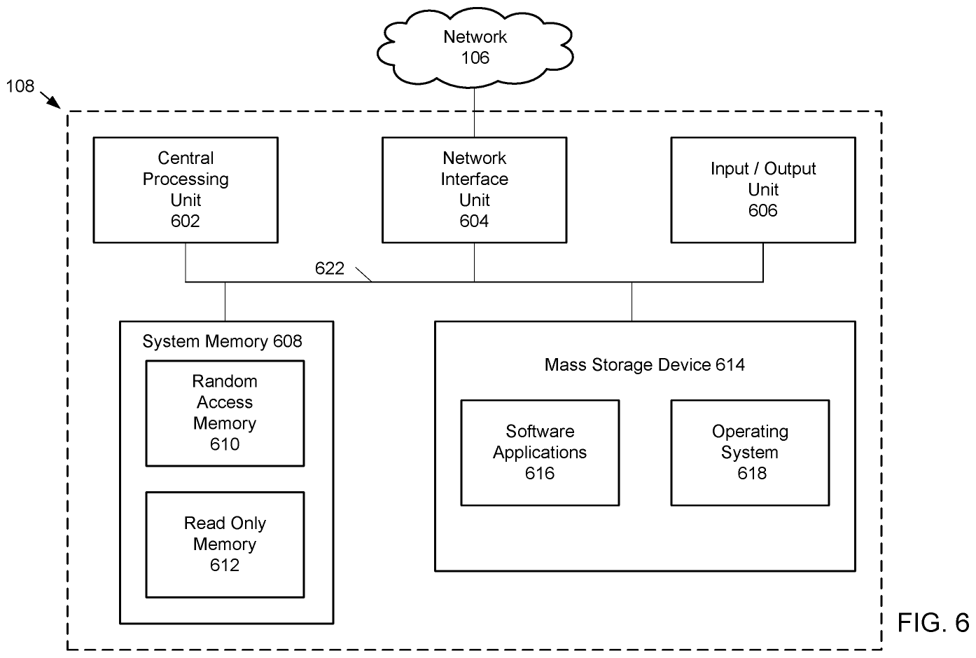

As illustrated in the example of FIG. 6, organization server computing device 108 includes at least one central processing unit (“CPU”) 602, also referred to as a processor, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the organization server computing device 108, such as during startup, is stored in the ROM 612. The organization server computing device 108 further includes a mass storage device 614. The mass storage device 614 is able to store software instructions and data. Some or all of the components of the organization server computing device 108 can also be included in client electronic computing device 102.

The mass storage device 614 is connected to the CPU 602 through a mass storage controller (not shown) connected to the system bus 622. The mass storage device 614 and its associated computer-readable data storage media provide non-volatile, non-transitory storage for the organization server computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 108.

According to various embodiments of the invention, the organization server computing device 108 may operate in a networked environment using logical connections to remote network devices through the network 106, such as a wireless network, the Internet, or another type of network. The organization server computing device 108 may connect to the network 106 through a network interface unit 604 connected to the system bus 622. It should be appreciated that the network interface unit 604 may also be utilized to connect to other types of networks and remote computing systems. The organization server computing device 108 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the organization server computing device 108 can store software instructions and data. The software instructions include an operating system 618 suitable for controlling the operation of the organization server computing device 108. The mass storage device 614 and/or the RAM 610 also store software instructions and software applications 616, that when executed by the CPU 602, cause the organization server computing device 108 to provide the functionality of the organization server computing device 108 discussed in this document. For example, the mass storage device 614 and/or the RAM 610 can store software instructions that, when executed by the CPU 602, cause the organization server computing device 108 to display received data on the display screen of the organization server computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for determining a loan discount for an existing loan for a student, the method comprising:
identifying, at the computing device, a plurality of attributes to determine the loan discount;
identifying, at the computing device, a group of college students who are from a plurality of different colleges;
receiving data via a Structured Query Language database query at the computing device, the Structured Query Language database query being constructed according to a schema including: (i) a group variance pointer to an area of memory providing a group variance value measuring variances between the student and the group of college students; and (ii) a scalar score for the student identifying the area of memory for the scalar score for the student based on final attribute weightings for the student;
comparing, at the computing device, a score for each attribute of the plurality of attributes for the student with an average score for a corresponding attribute for the group of college students, wherein the score is a data point for each attribute of the plurality of attributes from each student in the group of college students;
adjusting, at the computing device, a weighting for one or more of the attributes based on the comparing of each score for the one or more attributes for the student with the average score for the one or more attributes for the group of college students;
using the adjusted weighting for the one or more attributes for the student to calculate an adjusted score that determines whether the student qualifies for the loan discount, including:
calculating the scalar score for the one or more of the attributes by multiplying the adjusted score with the group variance value, the group variance value being associated with external events; and
translating the scalar score to a discount percentage using a lookup table; and
when a determination is made that the student qualifies for the loan discount by comparing the discount percentage to a maximum discount percentage, automatically calculating an amount of the loan discount.

2. The method of claim 1, further comprising:
determining an initial weighting for each of the plurality of attributes.

3. The method of claim 1, further comprising:
further adjusting the weighting for the one or more attributes for the student based on comparing the score for each of the one or more attributes with a score for the one or more of the attributes for each student in the group of college students; and
using the further adjusted weighting for the one or more attributes for the student to calculate the score that determines whether the student qualified for the loan discount.

4. (canceled)

5. The method of claim 1, wherein using the adjusted weighting for the one or more attributes for the student to calculate the score that can determine whether the student can qualify for the loan discount comprises:
selecting a subset of the plurality of attributes; and
for each attribute in the subset of the plurality of attributes, obtaining an attribute score by multiplying the adjusted weighting for the attribute by a variance between the score for the attribute for the student and the average score for the attribute for the group of college students.

6. The method of claim 5, further comprising:
for each attribute in the subset of the plurality of attributes, determining whether one or more events have occurred that could have affected student performance; and
when a determination is made that one or more of the events have occurred, adjusting the attribute score from a result of the multiplication to take into consideration an impact of the one or more events.

7. The method of claim 5, further comprising:
averaging the attribute scores for each attribute in the subset of the plurality of attributes;
normalizing the average of the attribute scores to a scale between 1 percent and 100 percent; and
using a normalized average of the attribute scores to determine whether the student can quality for the loan discount.

8. The method of claim 7, further comprising:
obtaining a maximum amount of the discount; and
multiplying the normalized average of the attribute scores by the maximum amount of the discount to determine a percentage of the discount.

9. The method of claim 1, wherein comparing the numerical score for each attribute for the student with the average score for the same attribute for the group of college students further comprises:
calculating a deviation between the score for each attribute for the student with a deviation for the average score for the same attribute for the group of college students; and
obtaining for each attribute a variance number corresponding to the deviation, the variance number being proportional to the deviation.

10. (canceled)

11. The method of claim 1, wherein the plurality of attributes include attributes related to school grades, standardized test scores, and community service.

12. The method of claim 1, wherein the plurality of attributes include attributes related to student history and family history.

13. (canceled)

14. An electronic computing device, comprising:
a processor; and
a system memory, the system memory including instructions which, when executed by the processor, cause the electronic computing device to:
identify a plurality of attributes to determine a discount for an existing loan for a student;
determine a weighting for each of the plurality of attributes;
obtain a numerical score for each of the plurality of attributes for the student;
obtain data via a Structured Query Language database query, the Structured Query Language database query being constructed according to a schema including: (i) a group variance pointer to an area of memory providing a group variance value measuring variances between the student and a group of college students; and (ii) a scalar score for the student identifying the area of memory for the scalar score for the student based on final attribute weightings for the student;
for each of the plurality of attributes, calculate a variance between a numerical score for the attribute for the student and the numerical score for the attribute for the group of college students, wherein the numerical score is a data point for each attribute of the plurality of attributes from each student in the group of college students;
adjust the weighting for one or more of the plurality of attributes based on the variance for the corresponding attribute;
obtain a numerical score for each attribute for each of the group of college students;
for each of the plurality of attributes, calculate a variance between the numerical score for the attribute for the student and the numerical score for the attribute for each of the group of college students, the variance being associated with external events;
calculate the scalar score for the attributes through multiplication of the numeric score with the variance;
further adjust the weighting for the one or more of the plurality of attributes for the student based on the variance for the corresponding attribute between the numerical score for the attribute for the student and the numerical score for the attribute for each of the group of college students through translation of the scalar score to a discount percentage using a lookup table;
use the further adjusted weighting including the discount percentage for the one or more of the plurality of attributes for the student to calculate a score that can determine whether the student can qualify for the loan discount; and
when a determination is made that the student qualifies for the loan discount, automatically calculating an amount of the loan discount.

15. The electronic computing device of claim 14, wherein using the further adjusted weighting for the one or more attributes for the student to calculate the score that can determine whether the student can qualify for the loan discount comprises:
select a subset of the plurality of the one or more attributes;
for each attribute in the subset of the plurality of the one or more attributes, obtain an attribute score by multiplying the further adjusted weighting for the attribute by a variance between the numerical score for the attribute for the student and an average numerical score for the attribute for the group of college students;
average the attribute scores for each attribute in the subset of attributes;
normalize the average of the attribute scores to a scale between 1 percent and 100 percent; and
use a normalized average of the attribute scores to determine whether the student can qualify for the loan discount.

16. The electronic computing device of claim 15, further comprising:
obtain a maximum amount of the discount; and
multiply the normalized average of the attribute scores by the maximum amount of the discount to determine a percentage of the discount.

17. The electronic computing device of claim 15, further comprising:
for each attribute in the subset of the plurality of the one or more attributes, determine whether one or more events have occurred that could have affected student performance; and
when a determination is made that one or more of the events have occurred, adjusting the attribute score from a result of the multiplication to take into consideration an impact of the one or more events.

18. The electronic computing device of claim 14, wherein the plurality of attributes include attributes related to school grades, standardized test scores, and community service.

19. (canceled)

20. An electronic computing device comprising:
a processor; and
a system memory, the system memory including instructions which, when executed by the processor, cause the electronic computing device to:
identify a plurality of attributes that can be used to determine a discount for an existing loan for a student;
determine a weighting for each of the plurality of attributes;
obtain a numerical score for each of the plurality of attributes for the student;
obtain data via a Structured Query Language database query, the Structured Query Language database query being constructed according to a schema including: (i) a group variance pointer to an area of memory providing a group variance value measuring variances between the student and the group of college students; and (ii) a scalar score for the student identifying the area of memory for the scalar score for the student based on final attribute weightings for the student;
for each of the plurality of attributes, calculate a variance between the numerical score for the attribute for the student and the numerical score for the attribute for the group of college students;
adjust the weighting for one or more of the plurality of attributes based on the variance for the corresponding attribute;
obtain a numerical score for each attribute for each student of the group of college students;
for each of the plurality of attributes, calculate a variance between the numerical score for the attribute for the student and the numerical score for the attribute for each student of the group of college students, the variance being associated with external events;
calculate the scalar score for the attributes through multiplication of the numeric score with the variance;
further adjust the weighting for the one or more of the plurality of attributes for the student based on the variance for the corresponding attribute between the numerical score for the attribute for the student and the numerical score for the attribute for each student of the group of college students through translation of the scalar score to a discount percentage using a lookup table;
use the further adjusted weighting including the discount percentage for the one or more attributes for the student to calculate a score that can determine whether the student can qualify for the loan discount, wherein the score is a data point for each attribute of the plurality of attributes from each student in the group of college students;
select a subset of the plurality of the one or more attributes;
for each attribute in the subset of the plurality of attributes, obtain an attribute score by multiplying the further adjusted weighting for the attribute by a variance between the numerical score for the attribute for the student and an average numerical score for the attribute for each of the group of college students;
obtain an average of each attribute score in the subset of the plurality of attributes;
normalize the average of the attribute scores to a scale between 1 percent and 100 percent;
use a normalized average of the attribute scores to determine whether the student can qualify for the loan discount;
obtain a maximum amount of the discount; and
multiply the normalized average of the attribute scores by the maximum amount of the discount to determine a percentage of the discount.

21. The method of claim 12, wherein the attributes related to student history are selected from being a high school valedictorian, being on the dean's list in college, being a social activist, having an internship in college, and having earned awards or scholarships.

22. The method of claim 12, wherein the attributes related to family history are selected from being the first in a family to graduate college, being the first in a family to attend college, an income of the student's parents, an education level of the student's parents, and an annual family income.

23. The method of claim 1, further comprising receiving a selection of the plurality of attributes from the student.
